(19) United States
(12) Patent Application Publication
(10) Pub. No.: US 2012/0326462 A1
(43) Pub. Date: Dec. 27, 2012

(54) ANTHROPOMORPHIC VEHICLE ACCESSORY

(76) Inventor: Robert A. Small, Park City, UT (US)

(21) Appl. No.: 13/168,791

(22) Filed: Jun. 24, 2011

(51) Int. Cl. B60R 13/02

(52) U.S. Cl. 296/1.08

(57) ABSTRACT

An anthropomorphic vehicle accessory is disclosed and described. The anthropomorphic vehicle accessory can include an interface portion to attach the accessory to a vehicle. Additionally, the anthropomorphic vehicle accessory can include a plurality of elongate strips resembling eyelashes coupled to and extending away from the interface portion.

### FIELD OF THE INVENTION

The present invention relates generally to automotive accessories and, more particularly, to accessories attached to an exterior of an automobile.

### BACKGROUND

Individuals customize automobiles in a variety of ways, including performance enhancements, audio equipment, comfort features, wheels, lift kits, lighting, paint, body kits, etc. Many automobile owners customize their automobiles as a way of expressing individuality or personality. As individuals, personality can be readily apparent in facial expressions and in the manner of dress and grooming. For many people, their automobiles are an extension of themselves. Thus, it is desirable to enable greater customization of automobiles to allow individuals to express their personality through their automobiles.

### SUMMARY

An anthropomorphic vehicle accessory is disclosed, which can be attached to an exterior of a vehicle to personify or impart a human characteristic to the vehicle. The anthropomorphic vehicle accessory can include an interface portion to attach the accessory to a vehicle. Additionally, the anthropomorphic vehicle accessory can include a plurality of elongate strips resembling eyelashes coupled to and extending away from the interface portion.

In one aspect, an anthropomorphic vehicle kit is disclosed. The anthropomorphic vehicle kit can include an anthropomorphic vehicle accessory having an interface portion to attach the accessory to a vehicle, and a plurality of elongate strips resembling eyelashes coupled to and extending away from the interface portion. The anthropomorphic vehicle kit can also include instructions for coupling the accessory to the vehicle.

In another aspect, a method of accessorizing a vehicle is disclosed. The method can include positioning an interface portion of an anthropomorphic vehicle accessory proximate to a vehicle surface, the accessory having a plurality of elongate strips resembling eyelashes coupled to and extending away from the interface portion. The method can also include coupling the interface portion to the vehicle surface.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

Features and advantages of the invention will be apparent from the detailed description that follows, and which taken in conjunction with the accompanying drawings, together illustrate features of the invention. It is understood that these drawings merely depict exemplary embodiments and are not, therefore, to be considered limiting of its scope. And furthermore, it will be readily appreciated that the components, as generally described and illustrated in the figures herein, could be arranged and designed in a wide variety of different configurations.

FIG. 1 is an anthropomorphic vehicle accessory attached to a vehicle, in accordance with one example.

FIG. 2 is an anthropomorphic vehicle accessory, in accordance with another example.

FIG. 3 is a side view of the anthropomorphic vehicle accessory of FIG. 2.

FIG. 4 is an anthropomorphic vehicle accessory, in accordance with still another example.

FIG. 5 is a composite anthropomorphic vehicle accessory, in accordance with an example.

FIG. 6 is an anthropomorphic vehicle accessory attached to a vehicle including multiple additional accessories simultaneously attached to augment the primary accessory, in accordance with another example.

FIG. 7 is a perspective view of a rounded installation of an anthropomorphic vehicle accessory in accordance with another example.

FIG. 8 is a perspective view of an anthropomorphic vehicle accessory having variable length lashes in accordance with yet another example.

### DETAILED DESCRIPTION

Reference will now be made to exemplary embodiments and specific language will be used herein to describe the same. It will nevertheless be understood that no limitation of the scope of the present invention is thereby intended. Alterations and further modifications of the inventive features described herein, and additional applications of the principles of the invention as described herein, which would occur to one skilled in the relevant art and having possession of this disclosure, are to be considered within the scope of the invention. Further, before particular embodiments are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

It must be noted that, as used in this specification and the appended claims, the singular forms “a,” “an,” and “the” include plural referents unless the context clearly dictates otherwise. Thus, for example, reference to “a member” includes one or more of such features and reference to “attaching” includes reference to one or more of such steps.

In describing and claiming the present invention, the following terminology will be used in accordance with the definitions set forth below.

As used herein, “substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context. Similarly, “substantially free of” or the like refers to the lack of an identified element or agent in a composition. Particularly, elements that are identified as being “substantially free of” are either completely absent from the composition, or are included only in amounts which are small enough so as to have no measurable effect on the composition.

As used herein, “about” refers to a degree of deviation based on experimental error typical for the particular property identified. The latitude provided the term “about” will depend on the specific context and particular property and can be readily discerned by those skilled in the art. The term “about” is not intended to either expand or limit the degree of equivalents which may otherwise be afforded a particular value. Further, unless otherwise stated, the term “about” shall expressly include “exactly,” consistent with the discussion below regarding ranges and numerical data.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

Dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a range of about 1 to about 200 should be interpreted to include not only the explicitly recited limits of 1 and 200, but also to include individual sizes such as 2, 3, 4, and sub-ranges such as 10 to 50, 20 to 100, etc.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Any steps recited in any method or process claims may be executed in any order and are not limited to the order presented in the claims unless otherwise stated. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

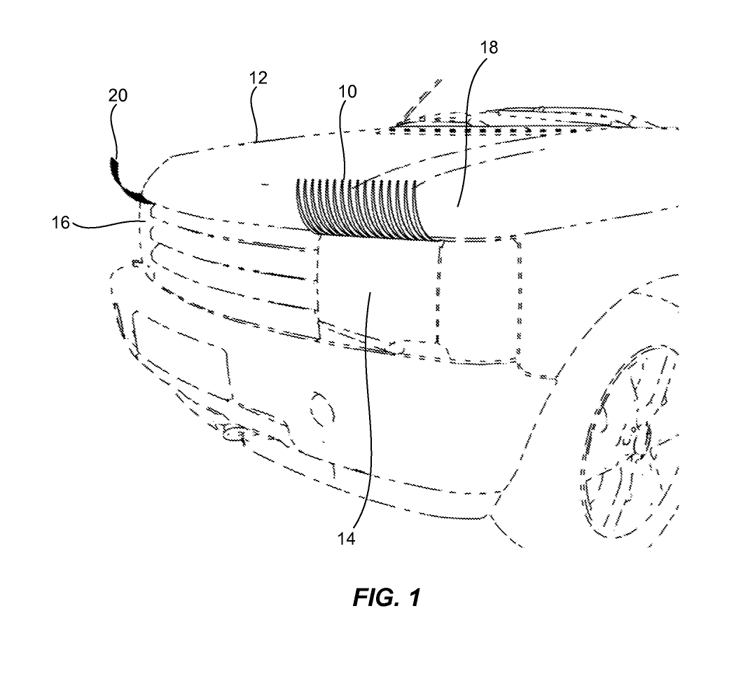

With reference to FIG. 1, illustrated is an anthropomorphic vehicle accessory 10 attached to a vehicle 12. The anthropomorphic vehicle accessory can impart a human form, characteristic, or attribute to the vehicle. In other words, the anthropomorphic vehicle accessory can personify the vehicle, or represent the vehicle in the form of a person. Thus, the anthropomorphic vehicle accessory can be used by a vehicle owner or operator to customize the vehicle to the owner or operator's personal taste. In one aspect, the anthropomorphic vehicle accessory can reflect the personality of the vehicle's owner. For example, the anthropomorphic vehicle accessory can reflect the owner's own sense of fashion or appearance. In this way, the owner can accessorize the vehicle to be an extension of the owner's own personality and preferences.

In a further example, the vehicle owner can configure an anthropomorphic vehicle accessory to convey a mood or emotion that may or may not reflect the owner's own present mood or emotion. In this case, the owner may opt to configure the anthropomorphic vehicle accessory to represent happy, sad, angry, lonely, or other human feelings or emotions that can be expressed through expressions or body language. Although an anthropomorphic vehicle accessory can include human body parts such as eyelashes, eyes, hair, etc., anthropomorphic vehicle accessory can also include man-made articles used by humans such as cosmetics, clothing, fashion accessories, etc. In another aspect, the owner may desire to accessorize the vehicle in a manner that is unrelated to the owner's personality and make a social, political, or artistic statement with the appearance of the vehicle. Such uses of an anthropomorphic vehicle accessory can thus be deemed a form of speech or artistic expression.

As illustrated in FIG. 1, the anthropomorphic vehicle accessory 10 can be attached to a surface of the vehicle 12 such that the accessory is visible on an exterior of the vehicle. For example, two anthropomorphic vehicle accessories 10, 20 are attached proximate to headlights 14, 16, respectively, and a hood 18 of the vehicle 12. In this case, the anthropomorphic vehicle accessories 10, 20 resemble eyelashes. Placement of the eyelashes proximate to the headlights takes advantage of existing headlights of a vehicle to form the impression that they are eyes of the vehicle. Thus, disposing the eyelashes above the “eyes” of the vehicle are suitable locations for anthropomorphic vehicle accessories resembling eyelashes. It should be noted, however, that an anthropomorphic vehicle accessory can be located anywhere on a vehicle and need not be associated with any particular part or feature of a vehicle.

The anthropomorphic vehicle accessories resembling eyelashes can be configured to convey human emotions or attributes. For example, the eyelashes can be directed upward to portray a surprised expression for the vehicle. In another example, the eyelashes can be angled downward across the accessory to portray a sleepy look for the vehicle. Similarly, the eyelashes can be angled downward at ends nearest the opposite headlight to provide expressions of anger.

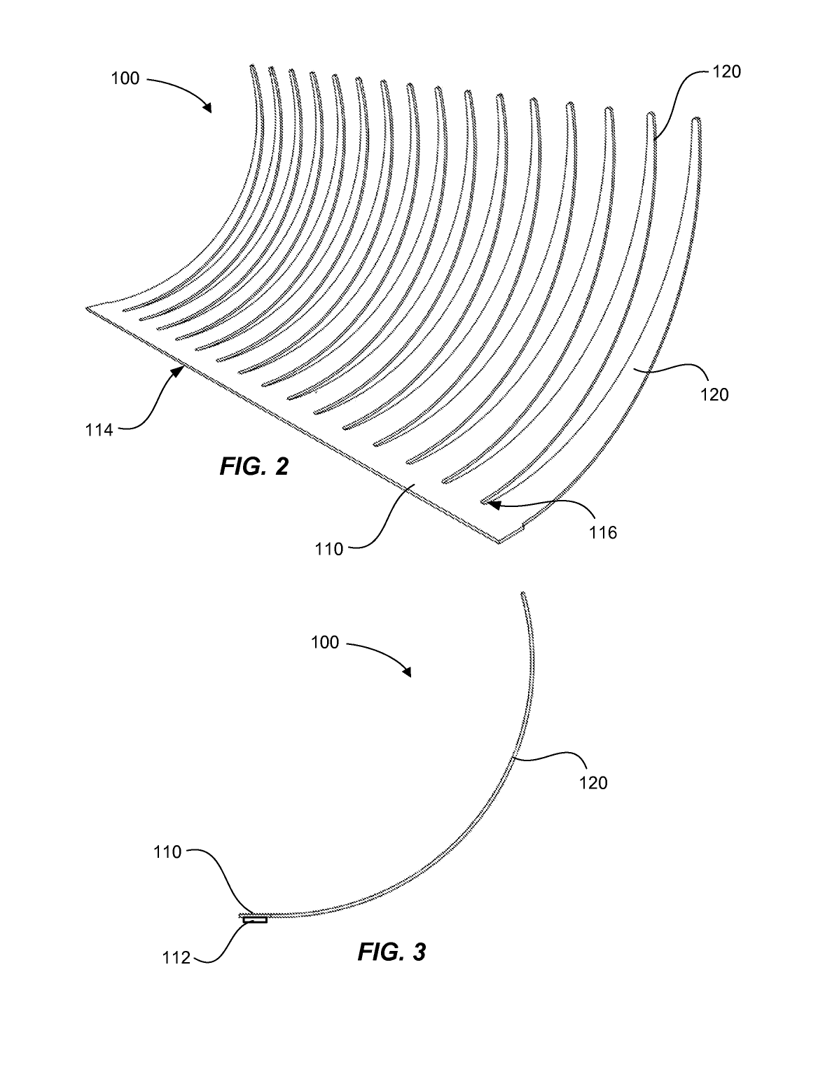

With reference to FIGS. 2 and 3, illustrated are detailed views of an anthropomorphic vehicle accessory 100. The anthropomorphic vehicle accessory 100 can include an interface portion 110 to attach the accessory to a vehicle. The interface portion 110 can be configured to support the anthropomorphic vehicle accessory 100 and maintain attachment integrity while the accessory is in use on the vehicle. For example, the interface portion 110 can be configured to withstand loads experienced by the anthropomorphic vehicle accessory while coupled to the vehicle, such as wind loads while driving, car wash brushes, handling or touching by intrigued passersby in a parking lot, etc. In addition, the interface portion 110 can be configured to maintain attachment integrity and withstand environmental conditions experienced by the vehicle, such as rain, dust, mud, sand, dirt, soap, bugs, sunlight, cold temperatures, hot temperatures, humidity, salt, salt water, road grime, car wax, etc. Any suitable material can be used for the interface portion 110, such as metals, polymers, composites, organics, etc. The interface portion can have a sufficient width and dimension to retain the elongate strips.

In one aspect, the interface portion 110 can be configured with a material and size to allow the interface portion to be flexible or rigid. For example, a flexible interface portion can conform to a vehicle surface when attached to the surface. A flexible interface portion, therefore, can be manipulated into a desired shape when the interface portion is attached to the vehicle. One benefit of a flexible interface portion is that a generic shape can be applied to a wide variety of vehicle surfaces.

For example, although the headlight illustrated in FIG. 1 provides a generally linear upper attachment surface, not all vehicles have linear upper surfaces. Often, the attachment surface can be upwardly curved such that a flexible interface portion 110 can allow for attachment to varying shaped contours around headlights. On the other hand, a rigid interface portion is resistant to deformation under loads associated with coupling the interface portion to the vehicle surface. A rigid interface portion, therefore, can be preformed to a predetermined shape before attachment to a vehicle. In another aspect, the interface portion 110 can comprise a single unitary construction or multiple components removably or permanently associated with one another to form the interface portion. Segmented construction can allow for more customized lengths, for example, by allowing a user to install more or fewer segments to achieve a desired appearance.

As illustrated in FIG. 3, the anthropomorphic vehicle accessory 100 can further include a vehicle coupling feature 112. The vehicle coupling feature can be operable with the interface portion 110 to couple the anthropomorphic vehicle accessory 100 to the vehicle. In other words, the interface portion 110 can be configured to receive or interface with a vehicle coupling feature 112. A vehicle coupling feature can comprise mechanical, chemical, electrical, magnetic, or other types of coupling technologies, alone or in combination, to couple the anthropomorphic vehicle accessory 100 to the vehicle. For example, the vehicle coupling feature can include an adhesive, a fastener, a clip, a clamp, a bracket, a snap, a magnet, or combinations thereof. In one aspect, illustrated in FIGS. 2 and 3, the interface portion comprises an elongate strip. The elongate strip can receive an adhesive 112, such as a glue, single-sided tape, double-sided tape, spray adhesive, etc. One non-limiting example of a double-sided adhesive tape is commercially available as 3M® Automotive tapes such as the 6300 line of products (e.g. 6376, 6382, 6384, 6386, Acrylic Plus™, etc.) and the like. The adhesive can be applied to the interface portion 110 and then the interface portion can be disposed on a surface of the vehicle. On the other hand, the adhesive can be applied to the surface of the vehicle and then the interface portion 110 can be disposed on the surface of the vehicle to contact the adhesive. The vehicle coupling feature 112 can provide a permanent attachment or a removable attachment to the vehicle. For example, magnetic strips can be adhesively attached to the interface portion 110 and then contacted with an underside of the hood adjacent the headlight. In another example, a hook and loop system can be used (such as Velcro®) to secure the interface portion to a vehicle. When using such removable coupling features it may be desirable to provide additional security to prevent tampering with the accessory. In one aspect, fore and aft ends of the coupling feature can be covered with a security latch to prevent lifting of the edges. Such security latches can include a key or other tool which engages with the latch to release the latch and allow access to the edges for removal, readjustment or replacement of the accessory.

Referring again to FIG. 2, the interface portion can optionally include posterior notches along the base edge 114. These posterior notches can provide additional flexibility to the interface portion 110 to allow for installation on contoured headlights. Further, the coupling feature, such as an adhesive strip, can be oriented along the interface portion 110 with an anterior edge which leaves the cusps 116 between each elongate strip 120 exposed. This can allow the coupling feature to have a continuous edge which is adhered or coupled to the interface portion 110. In another optional aspect, an additional reinforcement strip can be oriented along the interface portion such that the interface portion is between the coupling portion and the reinforcement strip. Such a reinforcement strip can help to prevent or reduce peeling of the elongate strips away from the coupling portion or the vehicle. This can also provide additional structural integrity among adjacent notched lashes.

In one aspect, a removable attachment allows the anthropomorphic vehicle accessory 100 to be removed from the vehicle without damaging the surface of the vehicle. For example, a mechanical coupling can be released, a chemical coupling can be dissolved or rendered ineffective, a magnet may be removed, etc. to minimize potential damage to a vehicle surface when removing the anthropomorphic vehicle accessory 100 from the vehicle.

With further reference to FIGS. 2 and 3, the anthropomorphic vehicle accessory 100 can also include a plurality of elongate strips 120. The elongate strips 120 can be coupled to and extend away from the interface portion 110. In one aspect, the elongate strips 120 can resemble eyelashes. Thus, in general, an anthropomorphic vehicle accessory can include an anthropomorphic feature that resembles a human characteristic, such as eyelashes, and an interface portion to couple the anthropomorphic feature to a vehicle. Such eyelash impression members can be in the form of elongate strips. A tapered contour can be provided to increase stiffness while also allowing for clear visual impression of eyelashes. Although the degree of tapering can vary, often the aspect ratio is from about 6 to about 25 (length to base width ratio), and in some cases from about 10 to about 20 aspect ratio. The thickness of the elongate strips can affect the flexibility of the strips, depending on the material. Although some flexibility can be desirable, sufficient rigidness can be provided to reduce or prevent curved members from angling back so far that tips thereof contact the vehicle hood under high rates of speed and/or wind. Over time such contact may damage clear coat and/or paint of a vehicle. Non-limiting examples of suitable materials can include vinyl, propylene, acrylic and polycarbonate polymers. In one example, the elongate members can be formed of a polypropylene or ABS polymer having a thickness from about 0.005 to 0.05 inches. Optional plasticizers and UV absorbers can be added to provide desired flexibility and UV resistance. Varying amounts of plasticizer may be desirable for different polymers, depending on relative flexibility.

The anthropomorphic feature and the interface portion can be a single unitary structure or separate and distinct components removably or permanently associated with one another to form the anthropomorphic vehicle accessory. Additionally, the anthropomorphic feature can comprise a single component or a plurality of components removably or permanently associated with one another to form the anthropomorphic feature. Although elongate strips can be unitary with the interface portion, individual elongate strips can be secured to the interface portion using any suitable mechanism. Non-limiting examples of such mechanisms can include gluing, snaps, hook and loop fasteners, magnets, and the like. Optional features can be provided to support the elongate strips. Such features can include buttresses which extend from a lower back side of the elongate strips to a surface of the vehicle.

The anthropomorphic feature can be configured to withstand loads experienced by the anthropomorphic vehicle accessory while coupled to the vehicle, such as wind loads while driving, car wash brushes, handling or touching by intrigued passersby in a parking lot, etc. In addition, the anthropomorphic feature can be configured to maintain structural integrity and withstand environmental conditions experienced by the vehicle, such as rain, dust, mud, sand, dirt, soap, bugs, sunlight, cold temperatures, hot temperatures, humidity, salt, salt water, road grime, car wax, etc. Any suitable material can be used for the anthropomorphic feature, such as metals, polymers, composites, organics, etc. Non-limiting specific examples include vinyl, polypropylene, steel, carbon fiber, polymer coated metals, polymer coated papers, and the like.

In one aspect, the anthropomorphic feature can be configured with a material and size to allow at least a portion of the anthropomorphic feature to be flexible or rigid. For example, a flexible anthropomorphic feature can be elastically deformed under normal vehicle operating conditions such that no permanent deformation results. In a particular example, a flexible anthropomorphic feature can be dynamic and movable in the wind, such as when the vehicle is moving. It may be desirable, however, to limit flexibility of the anthropomorphic feature so that excessive movement is prevented during normal use. For example, it may be undesirable to have flexible eyelashes deflect under wind loads such that the eyelashes curl backward to a surface of the car, such as the hood. Such excessive deflection can be visually unappealing as well as cause damage to a vehicle surface. Optional tip buffers can be included which minimize or eliminate potential damage if tips contact a vehicle surface. Tip buffers can provide a surface which distributes force across the vehicle surface. Non-limiting examples of such tip buffers can include brushes, rubberized knobs, flexible open loops, or the like.

In one aspect, flexibility of the anthropomorphic feature can enable a flexible interface portion to be manipulated into a desired shape when the interface portion is attached to the vehicle. On the other hand, a rigid anthropomorphic feature is resistant to deformation under loads associated with normal operation of the vehicle. A rigid interface portion, therefore, can remain substantially unaffected by wind forces as the vehicle moves. In another aspect, a flexible or rigid anthropomorphic feature can be configured as a generic shape that can be permanently or plastically deformed to be customized by a vehicle owner for a particular application. For example, eyelashes can be bent into a desired curve to achieve a particular look or appearance.

In certain aspects, the anthropomorphic vehicle accessory 100 resembling eyelashes can be sized proportional to a headlight, which can serve as an “eye” for the eyelashes. Thus, the eyelashes accessory may be between about 4 inches to about 20 inches in total width. The plurality of elongate strips 120 resembling the eyelashes can number from between about 2 to about 500, although from about 10 to about 25 elongate strips can often provide effective visual appearance. Each elongate strip can be from about 0.1 inch wide to about 3 inches wide. As shown in FIG. 2, the elongate strips can be tapered from a wide portion at a base end proximate to the interface portion 110 to a narrow tip at an opposite end from the wide portion. It should be noted, however, that no particular shape is required for the elongate strips and the strips can be of uniform width, variable width, or any other suitable configuration. Moreover, the strips can be of any suitable cross-sectional shape, such as a circle, rectangle, triangle, or any other polygon shape, free form shape, or combination thereof. Typically, the elongate strips can be oriented to extend away from the base and the vehicle to provide a three-dimensional effect which extends from the vehicle rather than being oriented flat against the vehicle surface.

In one example, the anthropomorphic vehicle accessory 100 resembling eyelashes can be constructed from a polymer sheet and the shape of the plurality of elongate strips as well as the interface portion can be stamped out of the polymer sheet. In one aspect, as illustrated in FIGS. 2 and 3, the plurality of elongate strips resembling eyelashes can be curved to more closely resemble human eyelashes. The curve can be applied either before or after the anthropomorphic vehicle accessory 100 has been attached to a vehicle. Such curving can be accomplished with thermoplastic polymers by heating and then retaining the curved orientation during cooling. Once cooled the accessory retains the applied shape. Metals and other elastically deformable materials can be merely bent into the desired shape.

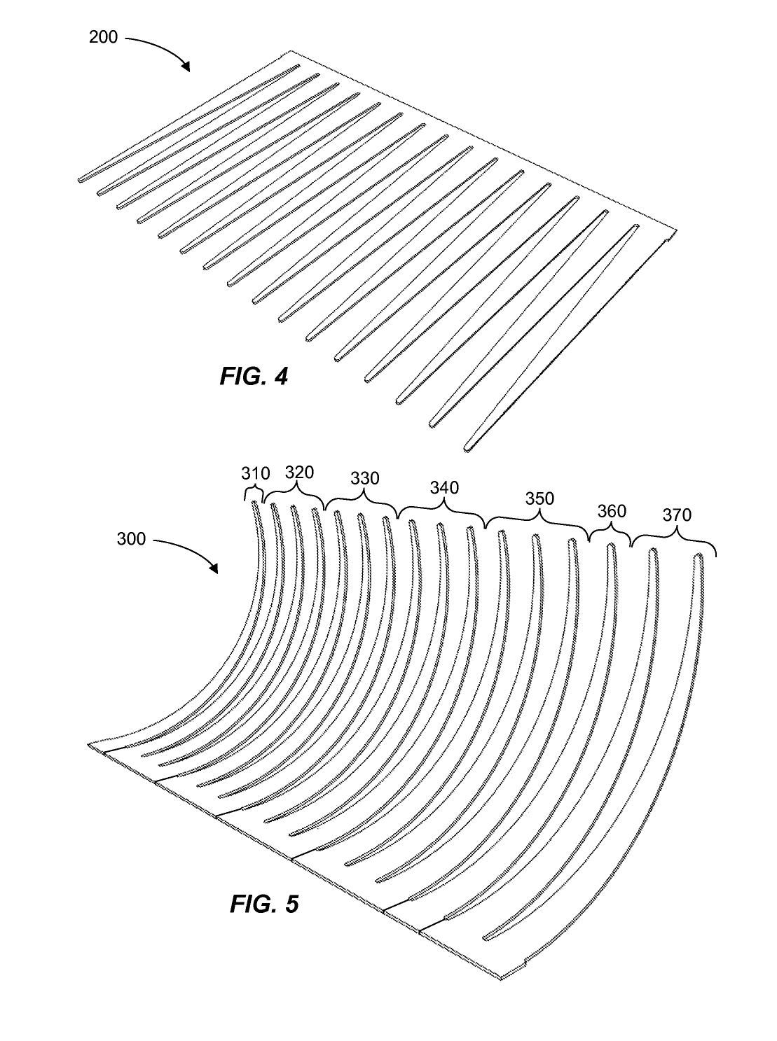

As illustrated in FIG. 4, an anthropomorphic vehicle accessory 200 resembling eyelashes can be in a flat configuration. The eyelashes can remain flat or a curve can be applied to one or more of the eyelashes to achieve a desired look. The curve can be applied either before or after the anthropomorphic vehicle accessory 200 has been attached to a vehicle.

With reference to FIG. 5, an anthropomorphic vehicle accessory 300 is shown. This figure illustrates that an anthropomorphic vehicle accessory can be a composite accessory comprising a plurality of modular components. For example, the composite anthropomorphic vehicle accessory 300 includes modular components 310, 320, 330, 340, 350, 360, and 370. The modular components include various numbers of eyelashes that can be combined in any arrangement or combination to achieve a desired accessory size or look. For instance, modular components 310 and 360 comprise a single eyelash, modular component 370 comprises two eyelashes, and modular components 320, 330, 340, and 350 each comprise three eyelashes.

Modular components having a variety of sizes or number of eyelashes can be combined to create a composite anthropomorphic vehicle accessory. For example, a headlight of one vehicle may be smaller than a headlight of another vehicle. A vehicle owner can select a number and combination of modular components to fit a given headlight size. Modularity can also be useful in tailoring eyelashes to a specific look or appearance. For example, modular components can include eyelashes of different lengths. Thus, modular components can be selected and combined to create an eyelash accessory that has eyelash lengths that vary along a width of the accessory. Additionally, modularity can enable the vehicle owner to replace damaged or broken modular components as needed without replacing the entire accessory.

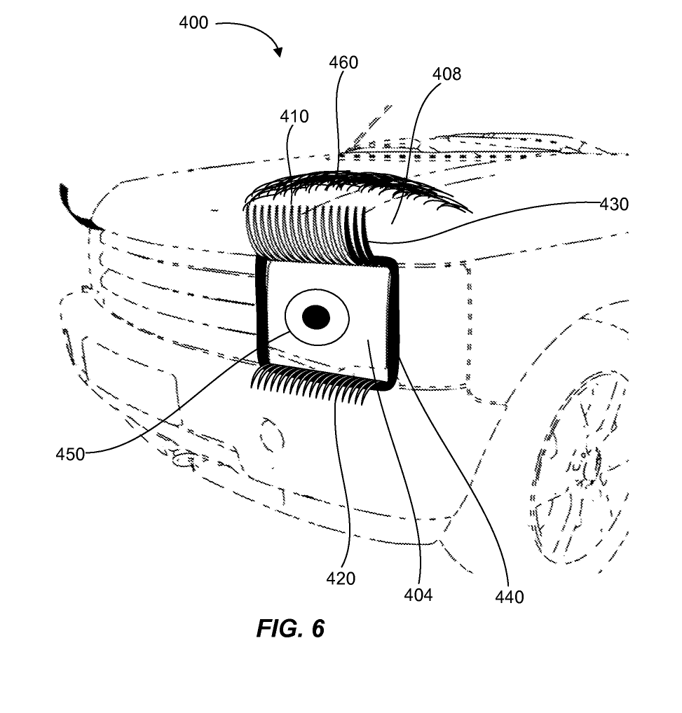

With reference to FIG. 6, an anthropomorphic vehicle accessory 400 is shown. This figure illustrates that an anthropomorphic vehicle accessory can include a plurality of anthropomorphic features. For example, the anthropomorphic vehicle accessory 400 includes anthropomorphic features 410, 420, 430, 440, 450, and 460. In particular, anthropomorphic feature 410 resembles upper eyelashes, anthropomorphic feature 420 resembles lower eyelashes, anthropomorphic feature 430 resembles mascara, anthropomorphic feature 440 resembles eyeliner, anthropomorphic feature 450 resembles a pupil, and anthropomorphic feature 460 resembles an eyebrow.

The upper eyelashes 410 can be similar to eyelashes discussed hereinabove. Likewise, the lower eyelashes 420 can be similar to eyelashes discussed hereinabove. For example, a plurality of elongate strips can resemble lower eyelashes. In one aspect, upper and lower eyelashes can be distinguished from one another by relative length. Upper eyelashes are generally longer than lower eyelashes.

In one aspect, the plurality of elongate strips can resemble eyelashes with mascara. For example, mascara 430 can be disposed on the elongate strips, such as with an adhesive. Mascara 430 can include glitter, jewels, crystals, etc. to adorn the upper eyelashes 410 and/or the lower eyelashes 420. Mascara 430 can include a variety of colors typically found in human cosmetics. Mascara 430 can be applied as a liquid or spray and can be imparted with adhesive qualities such that no additional adhesive is necessary.

The eyeliner portion 440 resembling eyeliner can be combined with or separate from other components of the anthropomorphic vehicle accessory 400. When separate, for example, the eyeliner portion 440 can be coupled to an eyeliner interface portion to attach the eyeliner portion to the vehicle. The eyeliner interface portion can be similar to the interface portion described hereinabove. The eyeliner 440 can be configured to create a border about all or part of an eye represented on the vehicle. For example, the eyeliner 440 in FIG. 6 is disposed about a headlight 404 of the vehicle. Materials, construction, and design considerations for the eyeliner can be similar to those of the eyelashes discussed hereinabove. Additionally, the eyeliner can include a variety of colors typically found in human cosmetics, as well as glitter, jewels, etc. In one aspect, the eyeliner portion can comprise a plurality of crystals. Such crystals (e.g. plastic or glass decorative crystals) can be attached along the eyeliner, eyelash base, eye shadow, or any other location to achieve a desired visual effect.

Furthermore, the anthropomorphic vehicle accessory 400 can include an eye shadow portion. The eye shadow portion can be disposed above the eyelash and formed to resemble an eyelid or coloration above the headlight to provide the impression of an eyelid. For example, stick-on vinyl film, patterns of crystals glued to vinyl films, optional clear protective stickers, glitter paints, and the like can be used to provide eyeshadow or other decorative affects. Materials, construction, and design considerations for the eye shadow can be similar to those of the eyelashes discussed hereinabove. Additionally, the eye shadow can include a variety of colors typically found in human cosmetics, as well as glitter, jewels, crystals, etc.

The pupil portion 450 resembling a pupil can be combined with or separate from other components of the anthropomorphic vehicle accessory 400. When separate, for example, the pupil portion 450 can be coupled to a pupil interface portion to attach the pupil portion to the vehicle. The pupil interface portion can be similar to the interface portion described hereinabove. One additional consideration, however, is that the pupil may be disposed on glass or plastic surface associated with the headlight 404. In one aspect, the pupil 450 can be located below the upper eyelash 410 and/or above the lower eyelash 420. Materials, construction, and design considerations for the pupil can be similar to those of the eyelashes discussed hereinabove. In addition, since the pupil 450 can be disposed on the headlight 404, a material selected for the pupil can be at least partially translucent to allow some amount of light from the headlight to pass through the pupil. For example, a colored plastic can be used to allow some light to pass through while still providing a decorative aspect for the anthropomorphic vehicle accessory 400. In one aspect, the pupil 450 can be modular, such as with concentric rings that are removable. In another aspect, the pupil 450 can include different sized rings that are interchangeable with one another. Thus, the size of the dark portion of the pupil can be customized for a desired look. For example, the pupil can be made to appear larger for a wide-eyed or surprised look. On the other hand, the pupil can be made to appear smaller for an angry or determined look such as by truncating a portion of the circular pupil shape.

The eyebrow portion 460 resembling an eyebrow can be combined with or separate from other components of the anthropomorphic vehicle accessory 400. When separate, for example, the eyebrow portion 460 can be coupled to an eyebrow interface portion to attach the eyebrow portion to the vehicle. The eyebrow interface portion can be similar to the interface portion described hereinabove. The eyebrow 460 can be located above upper eyelashes or eye shadow, such as on a hood or fender. Materials, construction, and design considerations for the eyebrow can be similar to those of the eyelashes discussed hereinabove. In one aspect, the eyebrow can include wire or polymer bristles or strands to simulate eyebrow hair. The eyebrow 460 can be a composite of modular components similar to the composite and modular components discussed hereinabove with reference to FIG. 5. Thus, the eyebrow 460 can be customized with different modular components to create an eyebrow with a desired look. For example, modular components can be combined in manner to create a thin, groomed eyebrow or to create a thick bushy eyebrow. Additionally, the eyebrow 460 can be reconfigurable on the vehicle to create a raised or lowered eyebrow look. Thus, the eyebrow 460 can be configured to express human emotion such as fear, surprise, anger, etc. In one related aspect, such expressions can be variable such that braking, acceleration or other driver actions can affect a change in position of one or more accessories. For example, a wireless remote link can be provided between an internal switch and an accessory actuator. The internal switch can be manually triggered by operation of the brake, accelerator or manual button or may be triggered using an OSB link (direct connection to an automobile computer which includes data about braking, acceleration, etc.). The accessory actuator can generally be a low profile actuator such as, but not limited to, a piezoelectric actuator, magnetic actuator, or the like.

In one aspect, the various anthropomorphic features of the anthropomorphic vehicle accessory 400 can be arranged or configured in concert to represent a desired look or expression. For example, the pupil, eyelashes, and eyebrow can all be arranged to present a scared expression. It should be noted, however, that each of the anthropomorphic features can be arranged or configured independently of the other features without regard to a harmonized look or appearance.

With further reference to FIG. 6, in one aspect, eyelash accessories 430 can be coupled to the vehicle using the hood 408 of the vehicle. For example, the interface portion can be “sandwiched,” at least in part, by the hood 408. In this case, the hood 408 can apply a clamping force to the interface portion with an edge of the hood. Such a coupling can be used alone or in combination with another type of coupling, such as an adhesive.

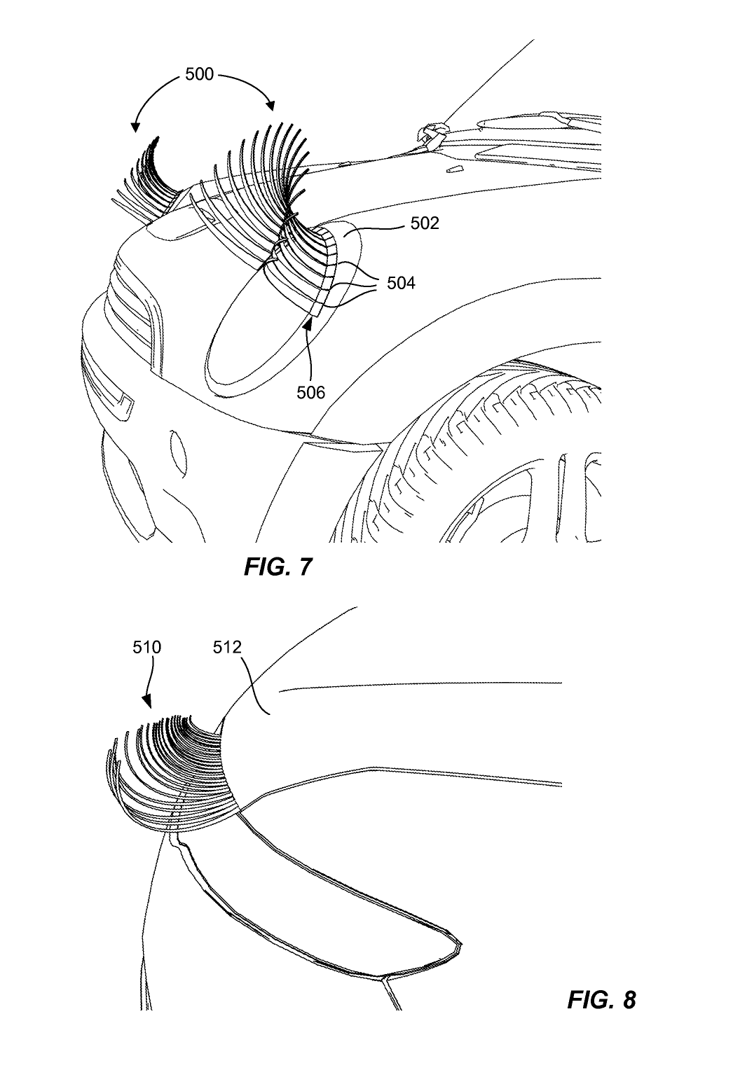

As previously mentioned, variations in shape and configuration can vary considerably consistent with the principles described herein. As examples of such variations FIG. 7 and FIG. 8 illustrate variations in installation contours of the interface portion and elongate strip shapes. Specifically, FIG. 7 shows upper eyelash accessories 500 which are mounted on a generally circular headlight rim 502. In this configuration, posterior notches 504 along the interface portion 506 allow for bending of the accessory.

Elongate strips can also be varied in shape and size within each vehicle accessory. Further, each elongate strip can be curved at differing angles to provide randomly positioned tips. This provides an affect which more closely mimics natural eyelashes which are typically randomly positioned (i.e. non-parallel and non-uniform). FIG. 8 provides an example of an eyelash accessory 510 having variable elongate strip lengths. As illustrated, inner lashes are shorter while outer lashes are progressively longer. Further, tips are shown offset such that some degree of random non-uniform orientation of the tips is provided. In this configuration, the interface portion and corresponding coupling portion is hidden and pinched between a lower surface of the hood 512 and an upper surface of the headlight.

It should be noted that an anthropomorphic vehicle accessory or components thereof can be disposed on any suitable vehicle surface and is not to be limited by the examples discussed herein. For instance, a suitable vehicle surface can include at least one of a headlight, a taillight, a hood, a trunk lid, a bumper, a door, or combinations thereof. Furthermore, a typical vehicle can be an automobile, although other vehicles such as, but not limited to, boats, golf-carts, all-terrain vehicles, motorcycles, mopeds, and the like can also be suitable subjects of the vehicle headlight accessories and systems described herein.

In one aspect, an anthropomorphic vehicle kit is provided. The anthropomorphic vehicle kit can include an anthropomorphic vehicle accessory, as discussed herein, and instructions for coupling the accessory to the vehicle. The anthropomorphic vehicle kit can also include a vehicle coupling feature operable with the interface portion to couple the accessory to the vehicle. The vehicle coupling feature can comprise an adhesive, a fastener, a clip, a clamp, a bracket, a snap, a magnet, or combinations thereof.

The instructions included in the anthropomorphic vehicle kit can include aspects of a method of accessorizing a vehicle. For example, a method of accessorizing a vehicle can comprise positioning an interface portion of an anthropomorphic vehicle accessory proximate to a vehicle surface, the accessory having a plurality of elongate strips resembling eyelashes coupled to and extending away from the interface portion. The method can also comprise coupling the interface portion to the vehicle surface. In one aspect, coupling the interface portion to the vehicle surface can comprise disposing an adhesive on at least one of the interface portion or the vehicle surface and disposing the interface portion on the vehicle surface. In a particular aspect, the adhesive can comprise a viscous glue or an adhesive tape. In another aspect, coupling the interface portion to the vehicle surface can comprise applying a force to the interface portion with an edge of a hood of the vehicle. In still another aspect, the vehicle surface can comprise at least one of a headlight, a taillight, a hood, a trunk lid, a bumper, a door, or combinations thereof. For example, in some aspects, the accessory such as an eyelash accessory can be most securely attached directly to an upper surface of a headlight. However, depending on the vehicle type, the interface portion may not be readily secured to the headlight. In such cases, the interface portion can be secured to an underside of a hood which, when closed, orients the eyelash accessory against the headlight.

In yet another aspect, positioning an interface portion and coupling the interface portion can be repeated for a plurality of accessories disposed adjacent one another to create a composite accessory. In a further aspect, the method can comprise causing the plurality of elongate strips resembling eyelashes to have a curved configuration. In still a further aspect, the method can comprise positioning an interface portion of at least one of an eyeliner portion, an eyebrow portion, and a pupil portion proximate to the vehicle surface and coupling the interface portion of the at least one of an eyeliner portion, an eyebrow portion, and a pupil portion to the vehicle surface. It is noted that no specific order is required in this method, though generally in one embodiment, these method steps can be carried out sequentially.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. Any steps recited in any method or process claims may be executed in any order and are not limited to the order presented in the claims. Accordingly, the scope of the invention should be determined solely by the appended claims and their legal equivalents, rather than by the descriptions and examples given above.

What is claimed is:

1. An anthropomorphic vehicle accessory, comprising:
an interface portion to attach the accessory to a vehicle; and
a plurality of elongate strips resembling eyelashes coupled to and extending away from the interface portion.

2. The accessory of claim 1, further comprising a vehicle coupling feature operable with the interface portion to couple the accessory to the vehicle.

3. The accessory of claim 2, wherein the vehicle coupling feature comprises an adhesive, a fastener, a clip, a clamp, a bracket, a snap, a magnet, or combinations thereof.

4. The accessory of claim 1, wherein the interface portion comprises an elongate strip.

5. The accessory of claim 1, wherein the plurality of elongate strips resembling eyelashes are curved.

6. The accessory of claim 1, wherein the plurality of elongate strips are tapered.

7. The accessory of claim 1, wherein the plurality of elongate strips resemble lower eyelashes.

8. The accessory of claim 1, wherein the plurality of elongate strips resemble eyelashes with mascara.

9. The accessory of claim 1, further comprising an eyeliner portion resembling eyeliner and having an eyeliner interface portion to attach the eyeliner portion to the vehicle.

10. The accessory of claim 9, wherein the eyeliner portion comprises a crystal.

11. The accessory of claim 1, further comprising an eyebrow portion resembling an eyebrow and having an eyebrow interface portion to attach the eyebrow portion to the vehicle.

12. The accessory of claim 1, further comprising a pupil portion resembling a pupil and having a pupil interface portion to attach the pupil portion to the vehicle.

13. An anthropomorphic vehicle kit, comprising:
an anthropomorphic vehicle accessory having
an interface portion to attach the accessory to a vehicle, and
a plurality of elongate strips resembling eyelashes coupled to and
extending away from the interface portion and the vehicle; and
instructions for coupling the accessory to the vehicle.

14. The kit of claim 123, further comprising a vehicle coupling feature operable with the interface portion to couple the accessory to the vehicle.

15. The kit of claim 4, wherein the vehicle coupling feature comprises an adhesive, a fastener, a clip, a clamp, a bracket, a snap, a magnet, or combinations thereof.

16. A method of accessorizing a vehicle, comprising:
positioning an interface portion of an anthropomorphic vehicle accessory proximate to a vehicle surface, the accessory having a plurality of elongate strips resembling eyelashes coupled to and extending away from the interface portion; and
coupling the interface portion to the vehicle surface.

17. The method of claim 16, wherein coupling the interface portion to the vehicle surface comprises:
disposing an adhesive on at least one of the interface portion or the vehicle surface; and
disposing the interface portion on the vehicle surface.

18. The method of claim 177, wherein the adhesive comprises a viscous glue or an adhesive tape.

19. The method of claim 16, wherein coupling the interface portion to the vehicle surface comprises applying a force to the interface portion with an edge of a hood of the vehicle.

20. The method of claim 166, wherein the vehicle surface comprises at least one of a headlight, a taillight, a hood, a trunk lid, a bumper, a door, or combinations thereof.

21. The method of claim 16, wherein positioning an interface portion and coupling the interface portion are repeated for a plurality of accessories disposed adjacent one another to create a composite accessory.

22. The method of claim 166, further comprising causing the plurality of elongate strips resembling eyelashes to have a curved configuration.

23. The method of claim 16, further comprising:
positioning an interface portion of at least one of an eyeliner portion, an eyebrow portion, and a pupil portion proximate to the vehicle surface; and
coupling the interface portion of the at least one of an eyeliner portion, an eyebrow portion, and a pupil portion to the vehicle surface.
